(19) United States
(12) Patent Application Publication
(10) Pub. No.: US 2012/0047975 A1
(43) Pub. Date: Mar. 1, 2012

(54) Method and apparatus for continuously carbonizing materials

(76) Inventors: Albert Calderon, Bowling Green, OH (US); Terry James Laubis, Portage, OH (US)

(21) Appl. No.: 12/807,265

(22) Filed: Sep. 1, 2010

(51) Int. Cl. C10B 7/00; C05F 11/02; C09K 3/00; C10B 57/04; C10J 3/00

(52) U.S. Cl. 71/24; 201/32; 201/14; 201/24; 202/103; 48/210; 252/372

(57) ABSTRACT

A method and apparatus for continuously carbonizing materials while co-producing gases in a coking chamber closed to the atmosphere, having a charger at one end comprising a pushing ram surrounding a mandrel that surrounds an air or oxygen injection lance. The other end of the coking chamber collects and separates coke from gases, with coke directed to a closed quenching chamber and gases directed to a cleanup. Thermal energy for converting coal into coke derives from combusting some metallurgical coal by said lance. In the case of producing coke from metallurgical coal, which is expensive because of limited supply, the herein method and apparatus are configured to separately charge a low-cost, abundant, carbonizing material and expensive metallurgical coal so that metallurgical coal surrounds the low-cost carbonizing material, and a lance combusts the low-cost carbonizing material, releasing thermal energy that heats metallurgical coal under reducing conditions, producing specification coke and gases more economically. After cleanup, gases are used as chemical feedstock or fuel. The word “coke” herein used may also be referred to as “charcoal” or “char.”

### INTRODUCTION

The present invention disclosed herein is an improvement of Applicant's patent entitled “Apparatus for Carbonizing Material,” bearing U.S. Pat. No. 5,639,353, issued on Jun. 17, 1997, hereinafter referred to as the “referenced patent.”

### BACKGROUND

Referring to the drawings, the specification, and the claims disclosed in the referenced patent, certain major and critical defects were identified when the reference patent was attempted to be put into practice. These defects were in the following areas:
The makeup structure of the coking chamber;
Heat transfer during cokemaking operation;
Maintenance of the outer and inner walls of the coking chamber; and
High capital and operating costs.

### Defects in the Makeup Structure of the Coking Chamber

As shown in Supplement Figures A and B, heating tiles 40, which form walls 38 and 39, possess a great number of wall joints that must be sealed, especially in view of the operation being conducted at a positive pressure and at high temperature. Since both walls provide a taper that grows in diameter towards the discharging end of chamber 10, the number of tiles increases, which means more joints are created. Further, since each row of tiles is of different dimensions by virtue of the taper, separate patterns, molds, and cores have to be made for each row of outer wall 38 and for each row of inner wall 39.

Also, there is the issue of supporting inner wall 39 within chamber 10; it is conceivable that inner wall 39 can be supported at the charging end, which is at room temperature; however, it is inconceivable that inner wall 39 can be supported at the hot discharge end, as it will interfere with the discharging of the coke at the hot end. To accomplish a productive capacity of several tons of coke per hour from chamber 10, it is estimated that coking chamber 10 would measure some 40 feet in length; supporting, in a cantilevered fashion, the massive weight of the inner wall 39 from the cold end only, will cause the hot end of inner wall 39 to deflect downward at the hot discharge end, thus destroying the concentric configuration of annulus 37 and affecting its uniform heating.

### Defects in Heat Transfer During Cokemaking Operation

Referring in particular to FIG. 2 of the reference, numerals 47 and 49 represent steel pressure shells, numerals 46 and 48 represent insulation, numeral 40 represents the tiles, and numeral 38 represents the outer wall, while numeral 39 represents the inner wall. Upon heating concentric walls 38 and 39 by means of hot flue gas flowing through heating flues 41, both walls 38 and 39 expand, with outer wall 38 expanding towards pressure shell 47, while putting insulation 46 into compression, causing the joints of tiles 40 to tighten, thus providing a better seal between the joints of tiles 40 and resulting in improved heat transfer from wall 38; but with inner wall 39 expanding towards pressure shell 49, insulation 48 is put in tension, causing the joints between the tiles to loosen, thus making possible the flowing of uncontrolled leakage of flue gases towards shell 49; this phenomena results in deteriorated heat transfer from the inner wall. In addition, mechanical stresses are generated against the roots of tenons 44 and the sides of mortises 45, shown in FIGS. 4(a) and 4(b), respectively; such stresses are conducive to cause breakage at the roots of the tenons and the sides of the mortises.

It is to be noted in Supplemental Figures A and B, which are attached herein to facilitate description, two full-size commercial courses of tiles of silicon-carbide (nitride bonded) were specially manufactured as a test to determine whether or not it would be practical to put into commercial use an inner wall to simulate inner wall 39, represented in FIG. 2 of the referenced patent. With respect to the issue of interconnections between each tile in a row of tiles and the issue prevalent between rows that ever change in dimension by virtue of the required taper of each row of tiles, it was evident that such structure would not be dependable when inner wall 39 experiences cycles of expansion when heated, causing the joints to open and thereby inviting leakage towards steel shell 49, which can result in hot spots of the shell, thus weakening it.

### Defects in the Maintenance of the Outer and Inner Walls of the Coking Chamber

Since the tiles that makeup outer wall 38 and inner wall 39 of coking chamber 10 interlock with one another, it is not possible to replace damaged tiles as the inner wall must be removed from chamber 10, which is a major undertaking because of the massive weight and accessibility. This means that the entire chamber would have to be disengaged from the steel tower building in which would be housed, brought down to ground level, placed on a flat car, and transported to the maintenance shop, while a spare chamber is mounted in place of the one that requires maintenance; in the meantime, serious losses in productivity would occur.

### High Capital and Operating Costs

Because of the special tiles, number of molds and cores, and the structure to support the massive weight of coking chamber 10, the project became so costly that it was decided to find technical and economic alternatives. Further, since the maintenance was expected to be severe, operating costs would also be excessive.

### OBJECTIVES OF THE INVENTION

The main object of the instant invention is overcoming the disadvantages stated above with respect to the referenced patent.

Another object of the present invention is the incorporation of the new improvements that are mentioned hereinafter to insure that the invention becomes technically practical.

Still another object of the present invention is to lower capital and operating costs in order to make the invention both technically as well as economically viable.

Further still, another object of the instant invention is to minimize the use of special, expensive metallurgical coal(s) to make specification coke by substituting some low-cost, abundant, non-metallurgical coal but still succeed in producing specification coke.

Therefore another object of the instant invention is to improve the quality of the coke produced.

These and other objects of the instant invention will become more apparent to those skilled in the art to which this invention pertains and particularly from the following description and appended claims.

### BRIEF DESCRIPTION OF DRAWINGS

FIG. 1 represents the side elevation of a plant incorporating the apparatus to carry out the improved method.

FIG. 2 is an illustration of the charging apparatus shown in section, with the material being represented in densely compacted condition being contained within the charging end of the carbonizing chamber.

FIG. 3 is the carbonizing chamber represented in partial section and illustrating the configuration wherein both metallurgical coal and non-metallurgical coal may be used in combination to reduce the amount of metallurgical coal used; metallurgical coal is by far more expensive than non-metallurgical coal, thus resulting in lowering the cost of producing specification coke. A view accompanying FIG. 3 is a section taken at A-A illustrating various parts, including the refractory/insulation lining, which is cast as a monolithic structure containing random imbedded metallic needles for reinforcement

FIG. 4 illustrates the front elevation of a commercial module that incorporates the apparatus to practice the improved method, which also includes the conversion of flue gas containing CO₂ into fertilizer.

FIG. 5 is the front elevation of a plurality of modules configured as a battery made up of four (4) modules incorporating the apparatus to practice the method in a large scale by making use of the replicability of the single module illustrated in FIG. 4.

Reference is now made to the accompanying drawings to enable the detailed description of the instant invention with the aid of numerals. These drawings form a part of the specification wherein like reference characters designate corresponding parts in the various views. By way of example, the material to be carbonized in this description will be directed towards the use of coal and its conversion into coke, which is mainly used in the making of blast-furnace iron, and also it is to be noted that the embodiments shown herein are for the purpose of description and not limitation.

### DETAILED DESCRIPTION OF THE DRAWINGS

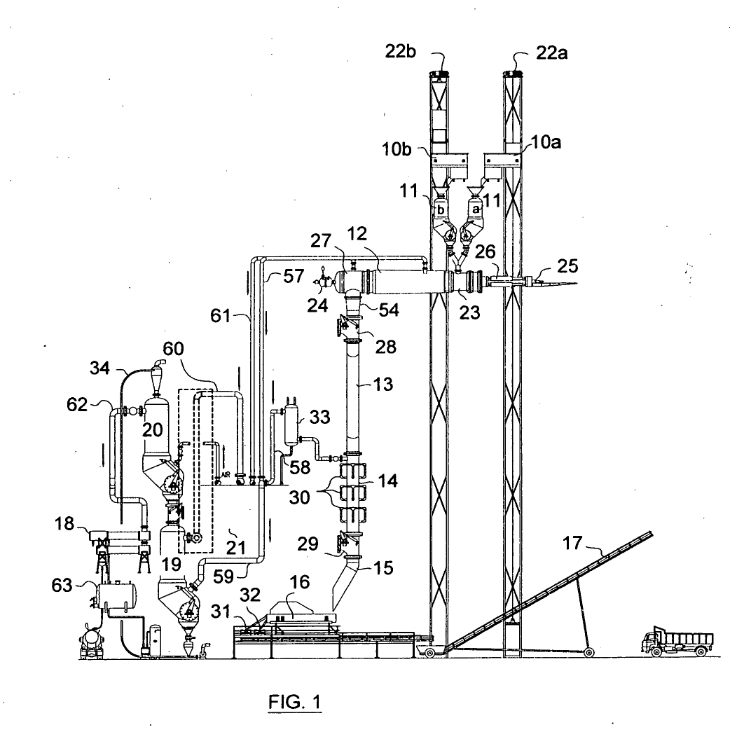

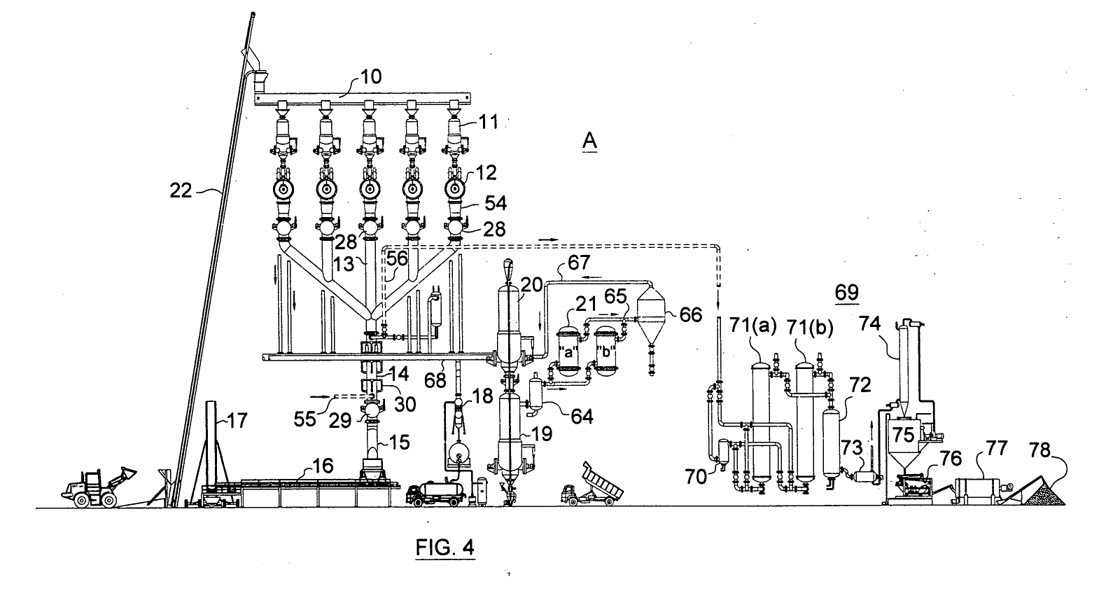

Referring to FIG. 1, which illustrates a side elevation of the miscellaneous equipment: numerals 10a and 10b represent two distribution conveyors; numerals 11a and 11b, two feed hoppers; numeral 12, a pyrolyzer (referred to as coking chamber 12); numeral 13, a downcomer; numeral 14, a coke quenching chamber; numeral 15, a coke chute; numeral 16, a coke screen; numeral 17, a coke stacker; numeral 18, a sulfur condenser; numeral 19, a cracker desulfurizer; numeral 20, a sorbent regenerator; numeral 21, a mercury removal space (omitted for clarity, but shown in FIG. 4); numerals 22a and 22b, skip hoists; numeral 23, a charging chamber; numeral 24, a start-up burner; numeral 25, an oxygen lance; numeral 26, a charger; numeral 27, an elbow; numeral 28, an upper control valve; numeral 29, a lower control valve; numeral 30, a coke quenching manifold; numeral 31, a coke product shuttle conveyor; numeral 32, a coke breeze shuttle conveyor; numeral 33, a gas separator; and numeral 34, a spent sorbent pneumatic conveyor.

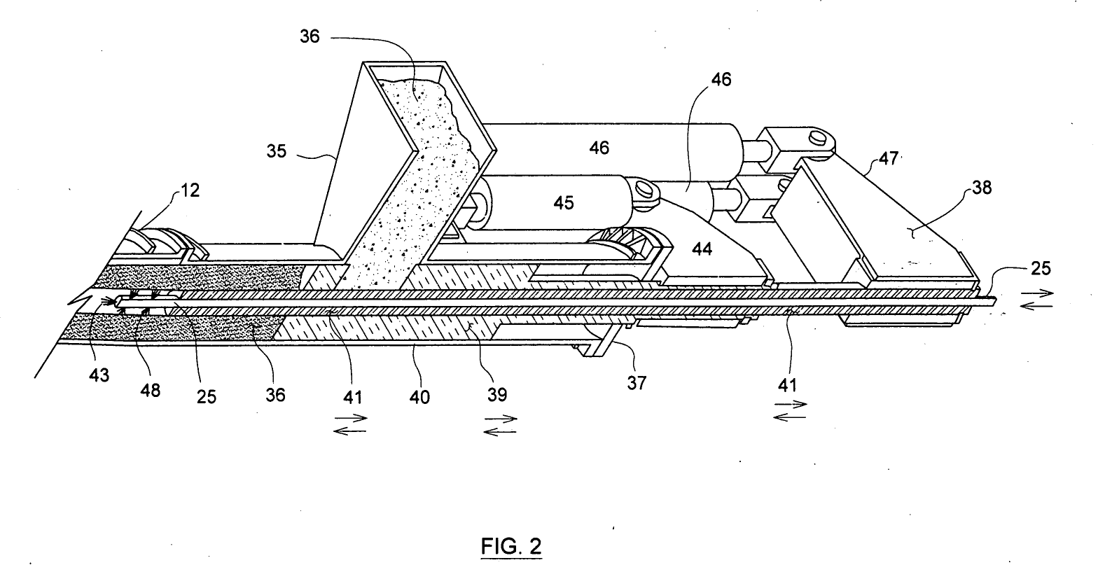

Referring to FIG. 2, it illustrates in detail the sectionalized structure of charger 26, which is made up of outer shell 40, within which ram 39 is caused to advance and retract by means of hydraulic actuator 45, with yoke 44 interconnecting actuator 45 to ram 39. During the retraction of ram 39, material 36 (such as coal) drops into shell 40 from feed chute 35, and as ram 39 advances, it compacts the loose coal 36 to increase its bulk density, which forces the entire contents of coking chamber 12 to move towards elbow 27, which is shown by FIG. 1.

In addition to ram 39, a mandrel marked by numeral 41, which is adapted to advance and retract independently from ram 39, with the push and pull action being effected by hydraulic actuators 46 that connect to mandrel 41 by means of yoke 47, which takes the form of a massive weldment marked by numeral 38. It is to be noted that ram 39 provides a bore through its center to accommodate mandrel 41 to pass through ram 39 in such a way that mandrel 41 is surrounded by ram 39. It is further to be noted that mandrel 41 takes the shape of a pipe with a bore of such a dimension as to accommodate lance 25 to directly pass through mandrel 41, and in essence pass indirectly through ram 39 by virtue of mandrel 41 passing through ram 39. Lance 25 serves as an injector of a gas containing oxygen in order to combust a small portion of coal plug 36 under suppressed condition (deficiency of oxygen), to generate the thermal energy required to devolatilize the coal and convert it into coke. The injection of the coal at a cold start is assisted by start-up burner 24, FIG. 1.

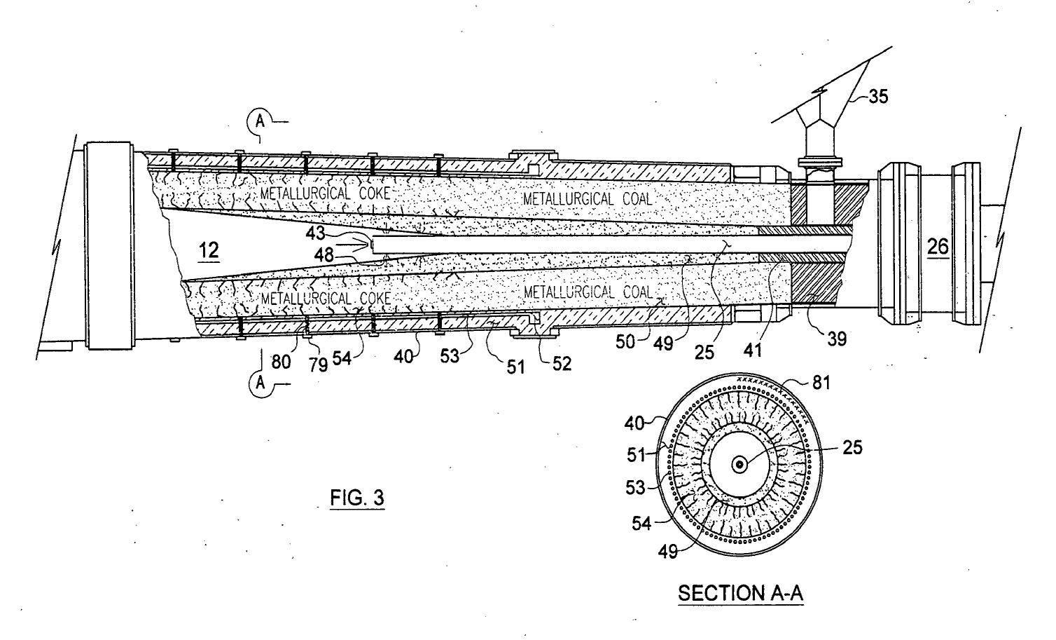

Referring now to FIG. 3, lance 25, in addition to its capability to inject the gas containing oxygen through its tip denoted by numeral 43, is equipped with injection nozzles on its side denoted by numeral 48. Lance 25, like mandrel 41 and ram 39, is adapted to advance and retract independently, and because of the high temperature surrounding lance 25, it is cooled preferably with water flowing through it.

It is to be noted that in providing lance 25 wherein some of the coal charged is combusted under suppressed conditions (in a pressurized, controlled reducing atmosphere), heat transfer within chamber 12 is markedly improved, thus enhancing the rate at which coal is converted to coke by heating the coal directly within chamber 12, resulting in increased productivity. Further, the coal/coke is heated peripherally by means of injection nozzles disposed through shell 40 and refractory 41, one of which being marked by numeral 80, with such nozzles being supplied with a gas containing oxygen furnished by manifold 79, thus providing direct, bi-directional, efficient heating.

In the making of coke for blast furnace use to convert iron ore into iron, a special coke is used; it is derived from special coal known in the ironmaking industry as “metallurgical coal.” Because of its scarcity, it is an expensive coal, especially when compared to other coals such as steam coal used in raising steam in boilers for thermal heating and/or the generation of power.

In the instant application wherein some coal is combusted in chamber 12, the objective is to minimize the combustion of metallurgical coal. To achieve this objective, numeral 12 is the coking chamber, numeral 26 is the charger, numeral 35 is the feed hopper, numeral 39 is the ram, numeral 41 is the mandrel, numeral 25 is the injection lance, numeral 43 is the nozzle at the tip of lance 25, and numeral 48 is one of the several nozzles disposed at the side of lance 25, numeral 49 is the non-metallurgical coal, numeral 50 is the metallurgical coal, numeral 51 is the refractory/insulation which is configured as a monolithic structure that is reinforced with metallic needles such as stainless steel needles, marked by numeral 81, somewhat similar to imbedding steel wire for reinforcing concrete; this structure is cast in place against shell 40.

In the case of heating the material peripherally directly by combusting material to be carbonized, the air or oxygen per se is introduced through shell 40 by means of injectors, one such injector being marked by numeral 80 supplied by manifold 79. In this case, where combustion takes place peripherally and the material is metallurgical coal, it is possible to also charge low-cost, non-metallurgical coal around the perimeter of the metallurgical coal to essentially minimize the combustion of expensive metallurgical coal by providing an additional mandrel that circumscribes ram 39 to form a ring of non-metallurgical coal around the peripheral of the metallurgical coal. In so doing, the combustion effected by injectors, such as injector 80, consumes the ring of non-metallurgical coal, instead of combusting peripherally expensive metallurgical coal. In the case of heating the material peripherally indirectly, numeral 52 is the manifold for distributing hot heating gas into a plurality of small-diameter flues installed in refractory/insulation 51, one such flue being marked by numeral 53 carrying hot gases that heat refractory 51, which in turn heats the material indirectly.

Referring now to FIG. 4, which represents the front elevation of the apparatus to practice the instant method, it illustrates a composite module marked by the letter A, which is made up of five coke-making chambers, one of which being denoted by numeral 12. The omitted mercury removal beds, mentioned when describing FIG. 1, are shown by numeral 21. An island to convert waste gas (flue gas containing CO₂) into fertilizer is marked by numeral 69; it comprises reactors 71(a) and 71(b), chiller 72, separator 73, hydrator 74, collection tank 75, filter press 76, drier 77, and fertilizer storage 78.

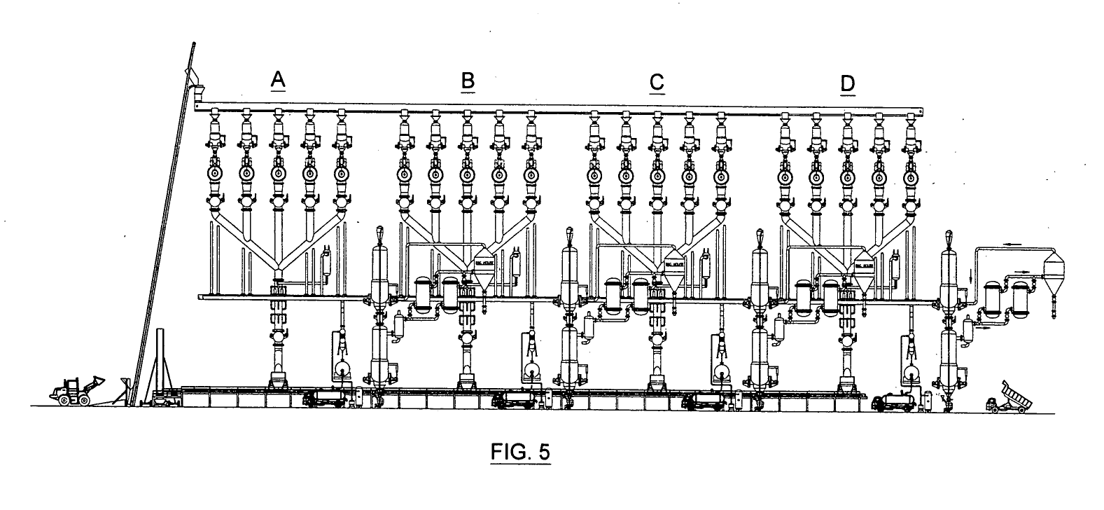

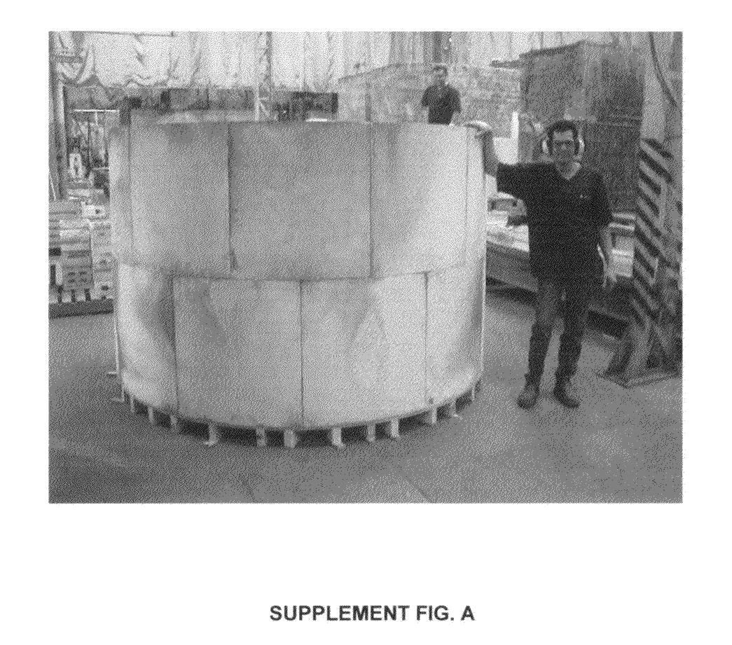

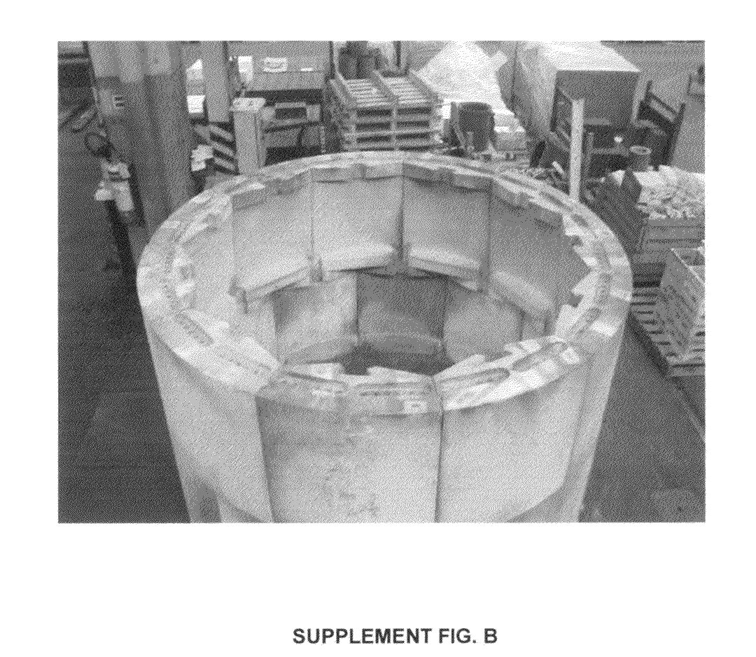

Referring to FIG. 5, it illustrates a battery of four identical modules marked by letters A, B, C, and D, assembled together to form a cokemaking plant as conceived in a commercial setting.

### OPERATION

Reference is now made to all Figures to explain the operation of the instant invention, with the explanation being initiated by making use of FIGS. 1 and 4, which illustrate the side and front elevations, respectively. In FIG. 4, the coal is shown to be hoisted from ground level to distribution conveyor 10 by means of skip 22, whereas in FIG. 1, it shows two skip hoists, 22(a) and 22(b), with one transporting metallurgical coal and the other non-metallurgical coal and distributing the separate coals by making use of conveyors 10(a) and 10(b), with 10(a) feeding into feed hopper 11(a) and 10(b) feeding into feed hopper 11(b), to accommodate the capability of charging both coals into coking chamber 12, according to the configuration represented in FIG. 3,

The conversion of the metallurgical coal into metallurgical coke, as illustrated in FIG. 3, takes place by employing lance 25 for directly heating the metallurgical coal by combusting the low-cost, non-metallurgical coal, which is surrounded by the metallurgical coal, under suppressed combustion conditions to devolatilize the metallurgical coal while hot gases (volatile matter) from the coal generated within chamber 12, flowing co-currently with the movement of the coke being formed within chamber 12 and being discharged into elbow 27 which is disposed at the end of chamber 12. Coke thusly formed is separated from the hot gases generated by the devolatilization of the coal. In essence, the movement of the hot coke changes from a substantially horizontal position to a vertical position at the discharge end of coking chamber 12, while the hot gases are directed into heating flues, like flue 53 shown in FIG. 3, with such flues being imbedded circumferentially in refractory 51 to indirectly heat the coal/coke peripherally, from the outer perimeter of the charge contained in chamber 12, with the hot gases flowing in the flues counter-current to the movement of the coal/coke within chamber 12. The hot gases in elbow 27, adjusted in temperature prior to entering the heating flues by way of manifold 52, provide the optimum condition for the efficient transfer of thermal energy to the coal/coke being moved within chamber 12 towards its discharging end as a result of the coal being compacted and continually pushed by means of charger 26. The coal thus converted into coke drops into a vertical transition holder marked by numeral 54, which is equipped with discharge valve 28; since Module “A,” shown in FIG. 4, comprises five identical coking chambers; each coking chamber is followed by such transition.

Downcomer 13 is made up of a plurality of pipes grouped together to form a manifold that enables the newly formed coke to be directed to coke quenching chamber 14, when the upper valves (such as valve 28) are individually opened in a predetermined sequence, thus guiding the hot coke from any of the five coking chambers into quenching chamber 14.

Quenching chamber 14, which is equipped with discharge valve 29, possesses several injection points at different elevations, marked by numeral 30 for injecting a coolant to drop the temperature of the coke to such a degree as to be discharged into the atmosphere without causing emissions. The coolant generally is water, but it can be steam or a gas, as for example flue gas containing CO2+N₂, which the hot coke in quenching chamber 14 can convert to 2CO+N₂, or a feedstock gas that can, in turn, be converted to a by-product such as fertilizer; it is to be noted that the injection of such gas is shown by dotted conduit 55 at the bottom of quenching chamber 14 and exiting at the top of chamber 14 marked by numeral 56. In the event that steam is injected by means of line 55, water gas (CO+H₂) can be formed; such gas may be directed to separator 33 for removal of excess moisture in the water gas. Periodically, valve 28 is closed while valve 29 is opened to discharge the quenched coke into chute 15, thence onto vibrating screen 16 wherein the undersized coke (known as “breeze”) is separated from the specification coke, which is transported by conveyor 31 to stacker 17 for storage.

It is to be noted that when injecting a gas containing CO₂ into the hot coke in quencher 14, the coke tends to cool; therefore, in using this injection practice, two coke-quenching chambers (“a” and “b”) are provided, with “a” being injected with gas containing CO₂, while the other is blown with air or oxygen in order to make up for the heat loss, and when “b” is being injected with gas containing CO₂, air or oxygen is blown through chamber “a” to raise its temperature. Instead of providing two quenching chambers, another approach is to use only one, but used when the hot coke is above the temperature at which the CO₂ is reduced to 2CO by making use of a by-pass valve to interrupt the flow of the gas when the coke stops reducing the CO₂ into 2CO.

By continuing to refer to FIGS. 1 and 4 for describing the flow of streams of gases, the raw gas from pyrolysis is represented by numeral 57, which emerges from coking chamber 12 to which stream 58 (raw water gas) is joined, forming stream 59 that enters at the bottom of cracker/desulfurizer 19, the lower vessel of the hot gas cleanup. The raw gas flows counter-current to the sorbent in cracker/desulfurizer 19 and emerges as a desulfurized gas at the top of this vessel as stream 60 (shown in dotted line in FIG. 1); this clean gas can be used as a fuel or as a chemical feedstock. Stream 61 is included to serve as a by-pass to stream 57, which is used in emergency or for maintenance purposes.

Once the sorbent in cracker/desulfurizer 19 is spent, the sorbent is transported from the bottom of cracker/desulfurizer 19 to the top of regenerator 20 by means of conveyor 34. During the regeneration of the sorbent, the sulfidated gas leaving the top of regenerator 20, by means of stream 62, is passed through sulfur condenser 18 to recover the sulfur in liquid form and stored in tank 63. In cases where the clean gas from the top of cracker/desulfurizer 19 needs to be treated for the removal of mercury, clean gas cooler 64 is provided, which cools the clean gas prior to being passed through an activated-carbon bed system marked by numeral 21, shown in FIG. 4; this system comprises beds “a” and “b,” with the practice being that when bed “a” is in absorption of mercury, bed “b” is in regeneration mode, and when bed “b” is in absorption, bed “a” is in regeneration mode.

The clean desulfurized gas devoid of mercury is then passed as stream 65 through bag-house 66 to remove any particulate matter, producing ultra-clean stream 67, which, destined to be used as fuel or chemical feedstock, is fed to gas main 68; it is to be noted that the joining of stream 67 to stream 68 is to be assumed that it is obstructed in FIG. 4 by the bottom of regenerator 20.

In cases where it is required that gases containing carbon dioxide (CO₂) need to be controlled because of climate change, by way of example, system 69 is provided (shown in FIG. 4) by putting CO₂ into beneficial use such as a fertilizer, rather than by capturing the CO₂ and sequestering it in a geologic formation, which requires continuous monitoring that results in added cost. The conversion of CO₂ into beneficial use may comprise cooler 70, intermediate reactors 71(a) and 71(b) for preparing the gas with the aid of a catalyst, chiller 72, separator 73, hydrator 74, collection tank 75, filter press 76, drier 77, and fertilizer storage 78.

Referring now to FIG. 5 as a commercial facility, it is made up of several modules by replicating the module, shown in FIG. 4, to accommodate a capacity determined by a specific market need which, by way of example, modules A, B, C, and D are assembled together as a battery, with each module operated generally as described.

The details of construction mentioned above are for the purpose of description and not limitation, since other configurations are possible without departing from the spirit of the invention. Further, other materials besides coal can be carbonized in the apparatus herein described.

Therefore, we claim the following:

1. A method for continuously carbonizing material in a carbonizing chamber having a charging end and a discharging end wherein said material is compacted at the charging end and pushed out of said chamber at its discharging end by the compacting action occurring at the charging end, which forces the advancing of said material within said chamber, comprising the following steps:
charging the material to be carbonized at the charging end of said carbonizing chamber;
heating said material directly by combusting a portion of said material within said chamber under a positive, pressurized, reducing atmosphere in such a way as to radiate thermal energy directly and continuously to said material while it is being advanced along the length of said chamber to cause the release of volatile matter contained in said material to result in co-producing a carbonized product in the form of a devolatilized carbonized material together with valuable gases;
directing said carbonized material and said gases towards the discharging end of said chamber;
separating said carbonized material from said gases;
feeding said carbonized material without being exposed to the atmosphere into a quenching chamber where its temperature is dropped below its ignition point while producing a quenched carbonized material; and
discharging said quenched carbonized material into the atmosphere without causing emissions.

2. The method as set forth in claim 1 is further characterized by a step of having said material also heated peripherally to increase the efficiency of carbonization.

3. The method as set forth in claim 2 wherein said step of having said material also heated peripherally is further characterized by the step of conducting such peripheral heating by means of combusting some of said material to release thermal energy to directly heat it.

4. The method as set forth in claim 2 wherein said step of having said material also heated peripherally is further characterized by conducting such peripheral heating indirectly with hot gases flowing thorough flues surrounding said material.

5. The method as set forth in claim 1 wherein said step of heating said material directly by combusting a portion of said material is further characterized by injecting a gas containing oxygen by means of a lance.

6. The method as set forth in claim 1 wherein said step of heating said material directly by combusting a portion of said material within said chamber is further characterized by the step of introducing a gas containing oxygen to support the act of combusting a portion of said material within said chamber in such a way as to release thermal energy from the inside of said material to radiate outwardly towards the refractory that surrounds said material within said chamber.

7. The method as set forth in claim 6 wherein said step of introducing a gas containing oxygen to support the act of combusting within said chamber is further characterized by the step of injecting said gas containing oxygen under pressure by means of a lance situated within said chamber.

8. The method as set forth in claim 7 wherein said step of injecting said gas containing oxygen under pressure by means of a lance is further characterized by the step of inserting said lance from the charging end of said chamber and providing the capability of advancing and retracting said lance to cause the release of thermal energy to efficiently heat the material within said chamber.

9. The method as set forth in claim 1 wherein the step of charging the material to be carbonized at the charging end of said carbonizing chamber is further characterized by the step of charging metallurgical coal into said coking chamber for its conversion into metallurgical coke.

10. The method as set forth in claim 9 wherein the step of charging metallurgical coal into said carbonizing chamber is further characterized by the step of also charging non-metallurgical coal, which is more economical than metallurgical coal, together with said metallurgical coal in such a way as to have the metallurgical coal, which is more expensive than said non-metallurgical coal, surround said non-metallurgical coal and combusting said non-metallurgical coal to release thermal energy to heat said metallurgical coal directly in order to carbonize the metallurgical coal into coke efficiently with thermal energy substantially derived from non-metallurgical coal.

11. The method as set forth in claim 3 wherein the step of conducting such peripheral heating by means of combusting some of said material to release thermal energy to directly heat it is further characterized by said material being metallurgical coal.

12. The method as set forth in claim 11 wherein said material being metallurgical coal is further characterized by the step of charging non-metallurgical coal together with metallurgical coal in such a way as to have the non-metallurgical surround said metallurgical coal and to combust such non-metallurgical coal peripherally to release a thermal energy to directly heat the metallurgical coal to convert it into coke, with thermal energy substantially derived from the non-metallurgical coal.

13. The method as set forth in claim 1 wherein the step of separating said carbonized material from said gases is further characterized by the step of feeding said gases into gas-cleaning systems wherein hydrocarbons are cracked, sulfur and mercury are removed while producing clean gases usable as chemical feedstock or fuel.

14. The method as set forth in claim 13 wherein said chemical feedstock is converted to fertilizer.

15. The method as set forth in claim 13 wherein said fuel is used for thermal energy applications.

16. The method as set forth in claim 15 wherein said fuel is used for thermal energy applications is further characterized by the step of combusting said fuel with air, producing CO₂+N2, or with oxygen per se producing CO₂.

17. The method set forth in claim 16 wherein said CO₂ is converted to 2CO, which serves as a feedstock that can be put to beneficial use, such as the manufacture of fertilizer.

18. Apparatus for continuously carbonizing material consisting of an integrated module comprising the following:
A plurality of carbonizing chambers, each of which is equipped with a charger adapted to charge and compact material within each one of said chambers by means of a reciprocating ram complimented by an independent reciprocating mandrel disposed through said ram in such as way as to have said ram surround said mandrel;
an injection lance passing through said mandrel for the injection of a gas containing oxygen adapted to combust a portion of said material under pressure and under suppressed combustion conditions to release thermal energy within said chamber to devolatilize said material to result in continuously co-producing a carbonized material and hot gases;
means to separate said carbonized material from said hot gases;
cleanup systems to clean said gases;
a quenching chamber to quench carbonized material below its ignition point;
a valve system to control the feed of hot carbonized material into said quenching chamber and the discharge of cooled coke out of said quenching chamber; and
a closed system integrating the various components of said apparatus to prevent the discharge of emissions into the atmosphere.

19. The apparatus as set forth in claim 18 being configured as a module comprising an assembly of a plurality of carbonizing chambers equipped with chargers, and other miscellaneous equipment to feed hot carbonized material from said carbonizing chambers into a quenching chamber to cool said carbonized material.

20. The apparatus as set forth in claim 19 comprising said module being replicated to form an assembly of modules installed side-by-side to form a battery of modules to constitute a commercial manufacturing plant at a scale acceptable to industry.
